(19) United States
(12) Patent Application Publication
(10) Pub. No.: US 2024/0211659 A1
(43) Pub. Date: Jun. 27, 2024

(54) CLASSIFICATION-BASED PRODUCT DESIGN USING VIRTUAL DIGITAL TWIN MODELS

(71) Applicant: INTERNATIONAL BUSINESS MACHINES CORPORATION, Armonk, NY (US)

(72) Inventors: Sarbajit K. Rakshit, Kolkata (IN); Sathya Santhar, Ramapuram (IN); Sridevi Kannan, Katupakkam (IN)

(21) Appl. No.: 18/088,080

(22) Filed: Dec. 23, 2022

(51) Int. Cl. G06F 30/27

(52) U.S. Cl. CPC G06F 30/27

(57) ABSTRACT

A system and method of automatically generating product designs is provided. In embodiments, methods include converting a digital twin model of a physical product having a primary design to a virtual digital twin model enabling user interactions with features of the virtual digital twin model in a virtual environment; collecting user interaction data generated from virtual interactions of users with the features of the virtual digital twin model in the virtual environment; generating sentiment data indicating a sentiment of the users associated with the virtual interactions of the users with the features of the virtual digital twin model; and inputting the user interaction data, the sentiment data, and different groups of the users into a trained machine learning (ML) predictive model, thereby generating, as an output of the ML predictive model, a different secondary design of the physical product for each of the different groups of users.

### BACKGROUND

Aspects of the present invention relate generally to automated product design systems and, more particularly, to automated product designs based on crowd-sourced interactions with virtual digital twin models.

A digital twin or digital twin model is a virtual representation of a real-word physical system or product that serves as an indistinguishable digital counterpart for purposes such as system simulation, integration, testing, monitoring and maintenance. A digital twin model simulation may be used during the designing process of a product. Sensor data used in the generation and utilization of digital twin models may be collected from Internet of Things (IoT) enabled devices, allowing for the capture of high-level information that can then be integrated into the virtual twin model.

Gamification is the application of typical elements of game playing (e.g., point scoring, competition with others, rules of play) to other areas of activity, typically as a technique to encourage engagement with a product or service. Virtual reality gamification refers to the application of elements of game play within a virtual environment to encourage the engagement of a user with a product or service via the virtual environment.

### SUMMARY

In a first aspect of the invention, there is a computer-implemented method including: converting, by a processor set, a digital twin model of a physical product having a primary design to a virtual digital twin model enabling user interactions with features of the virtual digital twin model in a virtual environment; collecting, by the processor set, user interaction data generated from virtual interactions of users with the features of the virtual digital twin model in the virtual environment; generating, by the processor set, sentiment data indicating a sentiment of the users associated with the virtual interactions of the users with the features of the virtual digital twin model; and inputting, by the processor set, the user interaction data, the sentiment data, and different groups of the users into a trained machine learning (ML) predictive model, thereby generating, as an output of the ML predictive model, a different secondary design of the physical product for each of the different groups of users.

In another aspect of the invention, there is a computer program product including one or more computer readable storage media having program instructions collectively stored on the one or more computer readable storage media. The program instructions are executable to: convert a digital twin model of a physical product having a primary design to a virtual digital twin model enabling user interactions with features of the virtual digital twin model in a virtual environment, wherein the digital twin model accurately mimics real-world features of the physical product; collect user interaction data generated from virtual interactions of users with the features of the virtual digital twin model in the virtual environment during gamification; generate sentiment data indicating a sentiment of the users associated with the virtual interactions of the users with the features of the virtual digital twin model; and input the user interaction data, the sentiment data, and different groups of the users into a trained machine learning (ML) predictive model, thereby generating, as an output of the ML predictive model, a different secondary design of the physical product for each of the different groups of users, wherein the different secondary design each include a unique combination of the features of the physical product.

In another aspect of the invention, there is system including a processor set, one or more computer readable storage media, and program instructions collectively stored on the one or more computer readable storage media. The program instructions are executable to: convert a digital twin model of a physical product having a primary design to a virtual digital twin model enabling user interactions with features of the virtual digital twin model in a virtual environment, wherein the digital twin model accurately mimics real-world features of the physical product; collect user interaction data generated from virtual interactions of users with the features of the virtual digital twin model in the virtual environment during gamification; generate sentiment data indicating a sentiment of the users associated with the virtual interactions of the users with the features of the virtual digital twin model; and input the user interaction data, the sentiment data, and different groups of the users into a trained machine learning (ML) predictive model, thereby generating, as an output of the ML predictive model, a different secondary design of the physical product for each of the different groups of users, wherein the different secondary design each include a unique combination of the features of the physical product.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the invention.

FIG. 3 depicts an overview of an automated classification-based product design system in accordance with aspects of the invention.

FIG. 4 shows a flowchart of an exemplary method in accordance with aspects of the invention.

FIG. 5 illustrates an exemplary use scenario in accordance with aspects of the invention.

FIG. 6 illustrates technical inputs of an automated product design system in accordance with aspects of the invention.

### DETAILED DESCRIPTION

Aspects of the present invention relate generally to automated product design systems and, more particularly, to automated product designs based on crowd-sourced interactions with virtual digital twin models. In embodiments, an automated product design system generates product designs, each having a unique combination of features, for different groups of consumers (users) based on crowd-sourced consumer interactions with digital twin models in a virtual environment. In implementations, a system provides a user interface enabling consumers to opt-in, enabling the system to access private or sensitive information about the consumers prior to the system accessing and/or obtaining the information.

In general, a digital twin or digital twin model may be created to accurately reflect, in a computing environment, an existing physical object (e.g., a wind turbine) using sensors that are fitted to the physical object, where the sensors produce data about different aspects of the object's features (e.g., performance). This sensor data may then be relayed to a processing system and applied to a digital twin model. The digital twin model can then be used to run simulations, study current performance, and generate potential improvements that can then be applied back to the actual physical product. A digital twin model can also be created for non-physical processes and systems, mirroring the actual processes or systems and allowing simulations to be run based on real-time data.

Sensor data used in the generation and utilization of digital twin models may be collected from Internet of Things (IOT) enabled devices, allowing for the capture of high-level information that can then be integrated into the virtual digital twin model. With an IoT platform, the virtual digital twin model becomes an integrated, closed-loop twin of a product or system that can be used to inform and drive strategy across a business.

Often, when any product is going to be launched in the marketplace, the manufacturer considers various classified groups of consumers (customers), and different versions of the product may be launched, where the different versions have different capabilities, functionalities and/or features. In one example, different versions of a product are launched for consumers at different geographic locations. Entities planning to launch a product with new features or functionalities, or a completely new product, often seek to obtain consumer feedback regarding features of the product in advance of the product launch date, in order to incorporate desired product changes based on the feedback before the product is launched. This avoids the costs of changing a product after it is physically launched and avoids potential consumer dissatisfaction with the launched product.

Current virtual twin product design systems do not enable automated product design development for different groups (classifications) of consumers based on crowdsourced data. Advantageously, embodiments of the invention constitute an improvement in the technical field of virtual twin product design systems by enabling the iterative development of unique versions of a product for different groups of consumers based on aggregated computer-derived sentiment of consumers in a virtual environment. Implementations of the invention monitor consumer interactions with a virtual digital twin model in a virtual environment to predict one or more physical versions of the product that would meet the needs of classified groups of consumers using a machine learning (ML) predictive model.

In aspects of the invention, the digital twin model of a product is made available to consumers (customers) within a virtual reality environment (e.g., with advertising), wherein the consumers can interact with a virtual version of the digital twin model with gamification, thereby generating consumer feedback data and sentiment data regarding the product. In embodiments, a system analyzes the consumer feedback data and sentiment data to classify the data and identify different versions of the physical product to be created for different groups of consumers.

In implementations, the system creates different versions of the digital twin model based on the consumer feedback and sentiment data. These different versions of the digital twin model may each be made available through the virtual reality environment, and additional consumer feedback and sentiment data gathered for the different versions of the digital twin model to identify new versions of the digital twin model for different groups of consumers. In this way, embodiments of the invention iteratively generate potential new versions of a product for one or more groups of consumers.

In embodiments, the system continues to iteratively generate new versions of the product to identify (1) if the consumer feedback data and sentiment data are within predetermined threshold limits, and (2) if a rate of change of the consumer feedback and sentiment data from a previous version of the product (or digital twin model of the product) is within a predetermined threshold limit. Once, the consumer feedback data, sentiment data, and rate of change of the consumer and sentiment data are within acceptable threshold limits, the system finalizes the versions of the digital twin (final versions of the product) and manufacturing of the final versions of the physical product can begin.

In embodiments, the system filters versions of the product to determine a subset of the versions of the product to transform into digital twins for entry into the virtual reality environment and/or for manufacturing, by analyzing: the consumer feedback and sentiment data for each version of the product; manufacturing capabilities with respect to each version of the product; and cost versus benefit for each version of the product.

It should be understood that, to the extent implementations of the invention collect, store, or employ personal information provided by, or obtained from, individuals (for example, biofeedback sensor data), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as Classification-based Product Design Using Interactive Digital Twin Models 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

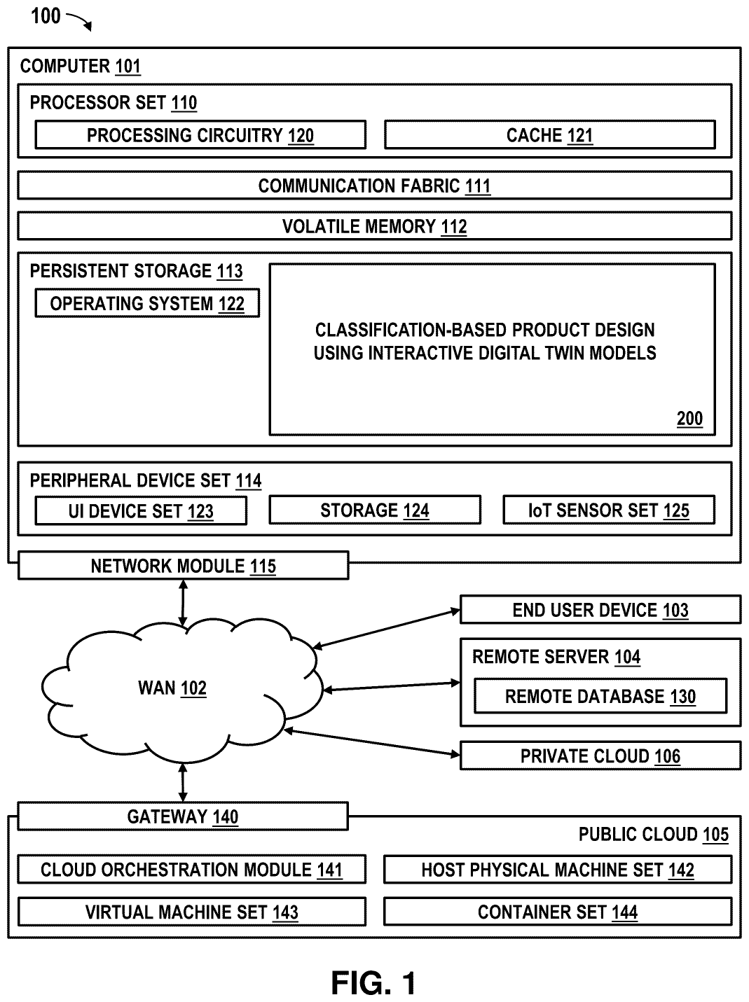

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

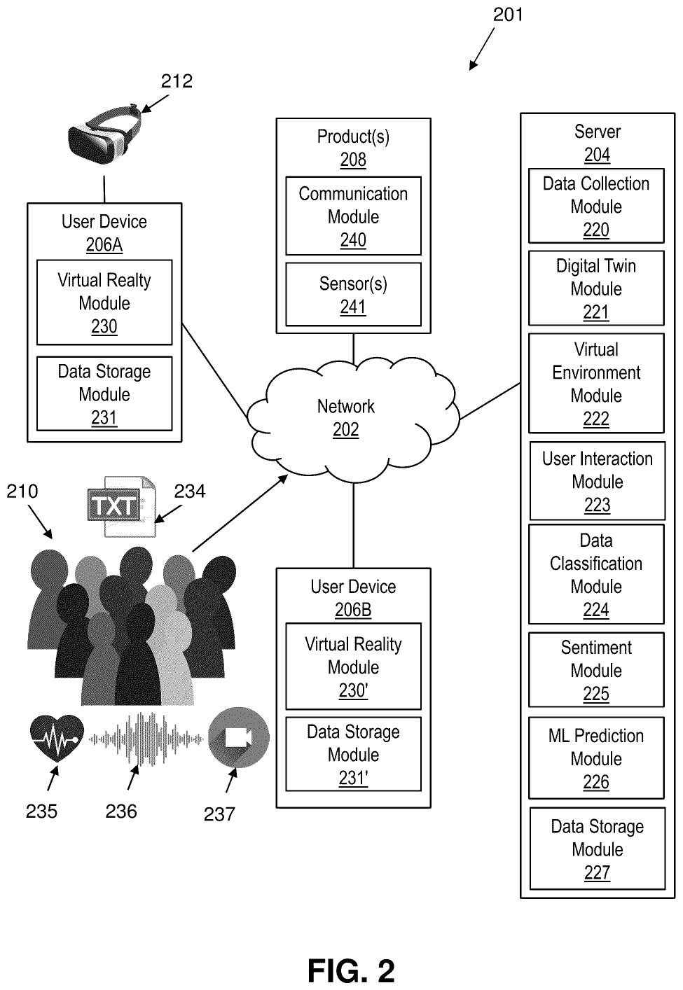

FIG. 2 shows a block diagram of an exemplary environment 201 in accordance with aspects of the invention. The environment 201 may be located within the computing environment 100 of FIG. 1. In embodiments, the environment 201 includes a network 202 (e.g., WAN 102 of FIG. 1) enabling communication between a server 204 and a plurality of user devices represented at 206A and 206B. In implementations, a physical product 208 is also in communication with the server 204 via the network 202.

The user devices 206A and 206B may each be an end user device 103 in FIG. 1. In implementations, the user devices 206A and 206B comprise computing nodes in a cloud computing environment. In embodiments, crowd-sourced information from a plurality of consumers represented at 210 is provided to the server 204 via one or more user devices (206A, 206B), which may be mobile computing devices, desktop computing devices, wearable electronic devices, internet of things (IOT) devices, or a combination thereof. In one example, a combination of a user device 206A and a wearable virtual reality (VR) headset 212 provides user interaction data to the server 204 via the network 202. In implementations, one or more physical products represented at 208, provide parameter data (e.g., sensor data) regarding features of the one or more physical products 208 to the server 204 via the network 202, either directly or via another computing device (e.g., remote server 104 of FIG. 1).

The server 204 may comprise an instance of the computer 101 of FIG. 1, or elements thereof. In aspects of the invention, the server 204 houses computer readable program instructions (e.g., the code in block 200 of FIG. 1) to cause a series of operational steps to be performed by processor sets (e.g., processor set 110 of FIG. 1) of the server 204, thereby effecting a computer-implemented method discussed in more detail below. The instructions of the server 204 may be stored as one or more modules in various types of computer readable storage media (e.g., persistent storage 113 of FIG. 1).

By way of example, the server 204 is depicted as including: a data collection module 220, a digital twin module 221, a virtual environment module 222, a user interaction module 223, a data classification module 224, a sentiment module 225, a machine learning (ML) prediction module 226, and a data storage module 227. In embodiments, a virtual reality module 230 of the user device 206A records user interaction data of a user in a data storage module 231 of the user device 206A, and is configured to share the user interaction data with the data collection module 220 of the server 204 via the network 202. The user device 206B is shown with a virtual reality module 230′ and data storage module 231′ having the same functions as the respective virtual reality module 230 and data storage module 231 of user device 206A. In implementations, data is generated during a user's interaction with a virtual environment provided by the virtual environment module 222 of the server 204, and may include text-based data 234, biofeedback data 235, audio data 236, image data 237, or combinations thereof, for example. In embodiments, the server 204 obtains user interaction data directly from a user device (e.g., user devices 206A, 206B) or via a third party computing device (when permitted).

In embodiments, the digital twin module 221 of the server 204 is configured to generate a digital twin model of the physical product(s) 208 based on parameter data (e.g., sensor data) obtained directly from the physical product(s) 208 (e.g., from the communication module 240) or from another computing device (not shown). In implementations, sensor data from sensors 241 of the physical product(s) 208 is obtained by the data collection module 220 of the server 204 and utilized by the digital twin module 221 to generate a digital twin model of the physical product(s) 208.

The server 204, user devices 206A and 206B, and physical product(s) 208 may each include additional or fewer modules than those shown in FIG. 2. In embodiments, separate modules may be integrated into a single module. Additionally, or alternatively, a single module may be implemented as multiple modules. Moreover, the quantity of devices and/or networks in the environment 201 is not limited to what is shown in FIG. 2. In practice, the environment 201 may include additional devices and/or networks; fewer devices and/or networks; different devices and/or networks; or differently arranged devices and/or networks than illustrated in FIG. 2.

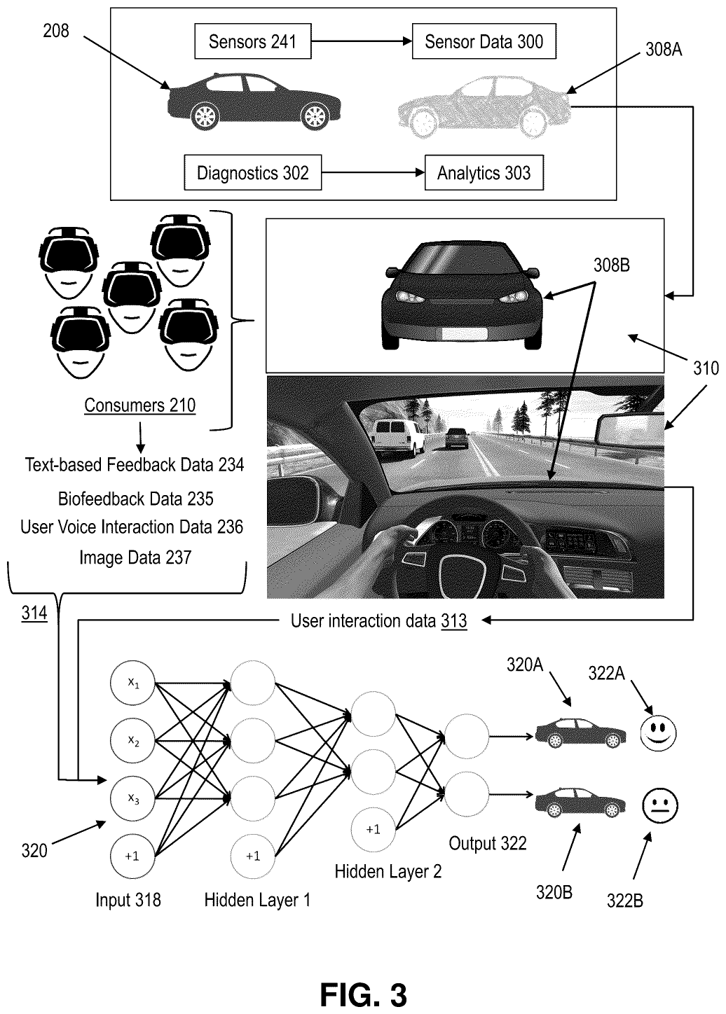

FIG. 3 depicts an overview of an automated classification-based product design system in accordance with aspects of the invention. Steps depicted may be carried out in the environment of FIG. 2 and are described with reference to elements depicted in FIG. 2.

In the example of FIG. 3, sensors 241 associated with a physical product 208 in the form of a car generate sensor data 300 regarding features (e.g., functions) of the physical product 208. Diagnostics information 302 regarding functions of the physical product 208 is utilized to generate analytics data 303. In implementations, the server 204 utilizes the sensor data 300 and analytics data 303 to generate a digital twin model 308A of the physical product 208, wherein the digital twin model 308A accurately mimics real-world features of the physical product 208 in a digital environment. The server 204 then provides a virtual digital twin model 308B in a virtual environment 310, wherein consumers 210 can access the virtual environment 310 to interact with the virtual digital twin model 308B, thereby generating user interaction data 313. Additional user interaction data 314 may be generated by the consumers 210 during their interaction with the virtual digital twin model 308 in the virtual environment 310, including text-based feedback data 234, biofeedback data 235, user voice interaction data 236, and image data (e.g., facial or gesture image data) 237. The user interaction data 313 and 314 may be processed to generate input data 318 of a desired type and/or format for input into an ML predictive model 320. For example, image data 237 may be processed using facial recognition or gesture recognition tools to provide insights into a consumers' interactions within the virtual environment 310.

In implementations, the ML predictive model 320 is trained with any required number of hidden layers (e.g., hidden layers 1 and 2), to generate a predictive output 322 in the form of versions of the product 208 predicted to satisfy the requirements of particular categories or groups of the consumers 210. In the example of FIG. 3, a first version 320A of the physical product 208 includes a first combination of features that are predicted to meet requirements of a first subset of the consumers 210 based on sentiment data represented at 322A, and a second version 320B of the physical product 208 includes a second combination of features that are predicted to meet requirements of a second subset of the consumers 210 based on sentiment data represented at 322B, wherein the first combination of features is different from the second combination of features and the first subset of the consumers 210 is different from the second subset of the consumers 210. In this way, the server 204 automatically generates classification-based product design options that are likely to satisfy different groups of consumers based on the interactive virtual digital twin model 308B in the virtual environment 310.

The server 204 (depicted in FIG. 2) may determine whether to update (add, remove of change) features of an initial or primary design of the physical product 208 for various groups of consumers. By way of example, features of the physical product 208 of FIG. 3 may include mileage (e.g., miles per gallon), paint color, tire type, headlight type, automatic or manual transmission, etc. In one exemplary scenario, the first version 320A of physical product 208 has features including 40-50 kilometers per liter (KMPL), a paint color of gold, sports tires, light emitting diode (LED) headlights, and an automatic transmission. The server 204 may compare these features to features of the initial or primary product to determine whether any changes would be required to meet the needs of a particular classified group of consumers.

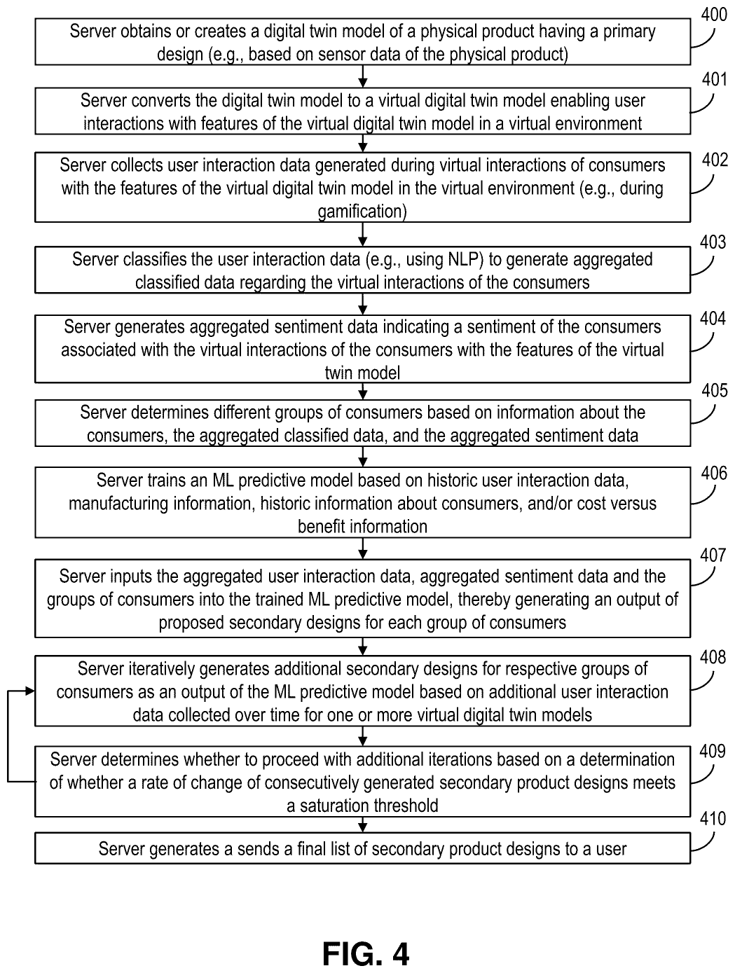

FIG. 4 shows a flowchart of an exemplary method in accordance with aspects of the invention. Steps of the method may be carried out in the environment of FIG. 2 and are described with reference to elements depicted in FIGS. 2 and 3.

At step 400, the server 204 obtains or creates a digital twin model 308A of a physical product 208 having a primary design (with an initial set of features). The term digital twin model as used herein refers to a virtual representation (virtual model) of a real-word physical product 208 that serves as an indistinguishable digital counterpart for purposes such as system simulation, integration, testing, monitoring and maintenance. In aspects of the invention, before any product of interest is to be launched, a manufacturer of the product 208 will create an initial design of the product 208 for testing, and the digital twin model 308A will be created based on the initial design. In aspects of the invention, the server 204 obtains the digital twin model 308A from a manufacturer or other third party who publishes the digital twin model 308A for public use. For example, a digital twin model 308A may be published for use in advertising in a virtual environment (e.g., 310).

Various methods of generating a digital twin model 308A may be utilized in accordance with implementations of the invention, and the invention is not intended to be limited to a particular method of generating a digital twin model 308A. In some embodiments, a digital twin model 308A is generated based on sensor data 300 of the physical product 208, which may be generated in real time as the physical product 208 is utilized. In embodiments, the digital twin module 211 of the server 204 creates the digital twin model 308A in accordance with step 400 based on sensor data 300 collected by the data collection module 220 of the server 204.

At step 401, the server 204 converts the digital twin model 308A to a virtual digital twin model (i.e., a virtual object) 308B enabling user interactions with features of the virtual digital twin model 308B in a virtual environment 310 via a user interface (e.g., a user interface of user device 206A and/or virtual reality headset 212). The virtual environment 310 may comprise an augmented reality environment, for example. In aspects of the invention, the virtual environment 310 provides a virtual reality interface with gamification (e.g., a gaming system, industry 4.0 application, or another digital media-based interface). In embodiments, consumers can utilize virtual reality devices (e.g., user devices 206A, 206B and/or virtual reality headset 212) to provide feedback on the physical products 208 at issue, which will be captured and stored by the server 204. In implementations, the virtual digital twin model 308B is generated for gamification, wherein the server 204 can capture how the physical product 208 will perform in the real world based on virtual actions within the virtual environment 310 executed by the virtual digital twin model 308B to generate an expected outcome. In embodiments, the virtual environment module 222 of the server 204 implements steps 401.

At step 402, the server 204 collects user interaction data (e.g., 313, 314) generated during virtual interactions of consumers 210 with the features of the virtual digital twin model 308B in the virtual environment 310 (e.g., during gamification). In implementations, the user interaction data is stored by the data storage module 227 in a local data storage area and/or a remote data storage area. User interaction data may include, for example, one or more of the following: voice commands or other audio data of a consumer accessing the virtual environment 310, text-based data obtained from a consumer accessing the virtual environment 310, gesture-based data of a consumer accessing the virtual environment 310 (e.g., captured as visual/video data), biofeedback data of a consumer accessing the virtual environment 312 (e.g., heartrate or other physiological data of a user obtained from a wearable device), user interaction data generated from virtual interactions of a consumer with the features of the virtual digital twin model 308B in the virtual environment 310, and derived information such as a consumer's patterns of use. In embodiments, the user interaction module 223 of the server 204 implements steps 402.

At step 403, the server 204 classifies the user interaction data (e.g., 210, 313) of the consumers 210 to generate aggregated classified data regarding the virtual interactions of the consumers 210. It should be understood that various methods of classifying data may be utilized by the server 204 in accordance with embodiments of the invention, and the invention is not intended to be limited to a particular method of data classification. In implementations, the sever 204 uses natural language processing (NLP) tools to classify user interaction data which was originally obtained as text-based data or converted to text-based data prior to classification. In embodiments, the classified data identifies successful actions and failed actions in the virtual environment 310. In implementations, the classified data classifies a consumer's feedback regarding different features (e.g., functionalities) of the virtual digital twin model. In aspects of the invention, user interaction data (e.g., audio or visual data) is processed prior to classification using image processing tools. In embodiments, the data classification module 224 of the server 204 implements steps 403.

At step 404, the server 204 generates aggregated sentiment data indicating the sentiment of the consumers 210 with respect to the virtual interactions of the consumers 210 with the features of the virtual digital twin model 308B. Sentiment data may be generated utilizing various computer-based sentiment derivation tools, and the present invention is not intended to be limited to a particular method of deriving sentiment data. By way of example, stacked deep learning models may be utilized to detect sentiment in a user's voice data (audio data). As another example, a Bidirectional Representation for Transformers (BERT) natural language processing (NLP) model may be utilized to classify sentiment based on a user's textual feedback (text data). As another example, a sentiment analysis model may utilize biofeedback data (e.g., sensor data such as brainwave, heart rate, and electrocardiogram data) to determine sentiment of users. In implementations, the server 204 uses various NLP and deep learning models to perform sentiment analysis and classify user interaction data (user feedback data) regarding a virtual reality product based on their needs, usage of functionalities, and their feature expectations and experience. In embodiments, the sentiment module 225 of the server 204 implements steps 404.

At step 405, the server 204 determines different groups of consumers 210 based on information about the consumers 210, the aggregated classified data, and the aggregated sentiment data. In implementations, the server 204 provides a user interface enabling consumers to opt-in to the server 204 accessing private or sensitive information about the consumers 210 prior to the server 204 accessing and/or obtaining the information. Information about the consumers 210 may be obtained directly from the consumers 210 and/or may be obtained through other authorized sources. Various classification methods may be utilized, and the present invention is not intended to be limited to any particular classification or grouping method. In implementations, in order to be considered a group for the purposes of the invention, the group of consumers must have meet a threshold number of consumers. For example, a group of fifty (50) similar consumers may not meet a predetermined threshold of two hundred (200) consumers, and therefore would not be considered a group for the purposes of predicting possible secondary versions of the product 208 at issue. In embodiments, the data classification module 224 of the server 204 implements steps 405.

At step 406, the server 204 trains at least one machine learning (ML) predictive model based on historic user interaction data to generate a version of a product that is predicted to be satisfactory to a particular group of consumers (class of consumers). The ML predictive model may also be trained based on product manufacturing information, historic information about consumers, and/or cost versus benefit information (e.g., rules) regarding features of the product 208. For example, historic training data may indicate that versions of the product having an overall cost (based on individual feature costs) exceeding a threshold amount do not result in profits exceeding a threshold amount. Accordingly, based on the training data or manual training inputs, the ML predictive model may be configured to compare overall costs of features with stored thresholds (cost vs benefit rules) when determining which versions of the product to output as predicted versions of the product to manufacture. In aspects, the server 204 uses a deep learning network which is trained on a database of historic user interaction data (user feedback data), feature expectations in different physical product models, and their successful sales data. In general, an ML predictive model for use in embodiments of the invention is a computer-based tool that predicts (as an output) features of a product necessary to meet requirements of a particular classification group by analyzing patterns in a given set of input data (user interaction data and data derived therefrom). In embodiments, the ML prediction module 226 of the server 204 implements steps 406.

At step 407, the server 204 inputs the aggregated user interaction data (or data derived therefrom), aggregated sentiment data, and the determined groups of consumers into the trained ML predictive model, thereby generating an output of proposed secondary designs (product designs) for each group of consumers. In embodiments, one or both of steps 404 and 405 are incorporated into step 407. For example, an ML model for sentiment classification may be utilized to derive sentiment data, which may then be fed to another ML model for predicting secondary designs of the product 208 that will satisfy a particular class of consumers. In aspects of the invention, based on different classified groups of consumers and product features required by the consumers, the server 204 identifies multiple different versions (e.g., 320A, 320B) of the physical product 208 to be created. In implementations, the server 204 maps predicted model types to different user groups and derives the predicted model types based on the user interaction data (feedback data including feature expectation data). In embodiments, the server 204 classifies features of the product at issue and identifies how many different types of models of the product might need to be launched by enhancing the functionalities and features to satisfy the classified user groups.

In aspects of the invention, the ML predictive model considers existing manufacturing capabilities, and the cost of different product features when determining the predicted versions of the virtual digital twin model or physical product 208, and how many different predicted versions of the virtual digital twin model or physical product 208 are to be created. In implementations, the ML predictive model is trained with historic data regarding manufacturing capabilities, costs of different product features, and versions of a product, to find patterns in the data, whereby the ML predictive model predicts different versions of the virtual digital twin model or physical product 208 based, in part, on the manufacturing capabilities and costs of different product features. For example, certain combinations of features may not be enabled by manufacturing capabilities, and will therefore will not be suggested as an output of the ML predictive model. In embodiments, the trained ML predictive model sets threshold values for one or more types of consumer feedback data and/or sentiment data regarding features of the physical product 208 at issue, wherein the consumer feedback data and sentiment data for a particular secondary design must meet the threshold values before a particular secondary design is proposed (output) by the ML predictive model. The ML predictive model may be trained by manual input of threshold values, or automatically based on determined patterns in historic training data. By way of example, the ML predictive model may be trained to disregard a version of the product as an output of the ML predictive model (predicted versions of the virtual digital twin model or physical product 208) when sentiment data indicates a negative or neutral response of consumers to a threshold number of features of the version of the product. In another example, the ML predictive model may be trained to disregard a version of the product as an output of the ML predictive model when consumer feedback data indicates a threshold number of consumers did not interact with a threshold number of features of the version of the product. In implementations, the server 204 generates multiple new digital twin models (e.g., 320A, 320B), wherein each new digital twin model is dedicated to a different class/group of consumers. In embodiments, the ML prediction module 226 of the server 204 implements steps 407.

At step 408, the server 204 iteratively generates additional secondary designs for respective groups of consumers 210 as an output of the ML predictive model based on additional user interaction data collected over time for one or more new virtual digital twin models (e.g., 320A, 320B). In this way, aspects of the invention continue to obtain feedback from consumers 210 for different versions of the physical product 208 (i.e., different virtual digital twin models) over time. In embodiments, the ML prediction module 226 of the server 204 implements steps 408.

At step 409, the server 204 determines whether to proceed with additional iterations of the product design method of FIG. 4, according to step 408, based on a determination of whether a rate of change of consecutively generated secondary product designs meets a saturation threshold. In implementations, the rate of change is calculated based on how different crowdsource users are providing the feedback, and based on a time scale indicating how often changes are made to the designs. In one example, one thousand (1000) participants are identified, and ten thousand (10,000) instances of feedback data are received in January. Later, new participants have been added and ten (10) new instances of feedback data are received in October. The server 204 in this example calculates how often changes are made to an iteration of a design based on the feedback data received. In embodiments, the ML prediction module 226 of the server 204 implements steps 409.

At step 410, the server 204 generates and sends a final list of secondary product designs to a user for consideration. In implementations, the final list comprises recommendations regarding which secondary product designs to manufacture. In aspects of the invention, a manufacturer will initiate production of various versions of a product 208 based on the secondary product designs generated by the server 204, and will provide the different versions of the physical product 208 to respective consumer groups. In aspects, the secondary product designs have not yet been manufactured, such that the final list comprises versions of the physical product 208 that have not yet been produced. In embodiments, the ML prediction module 226 of the server 204 implements steps 410.

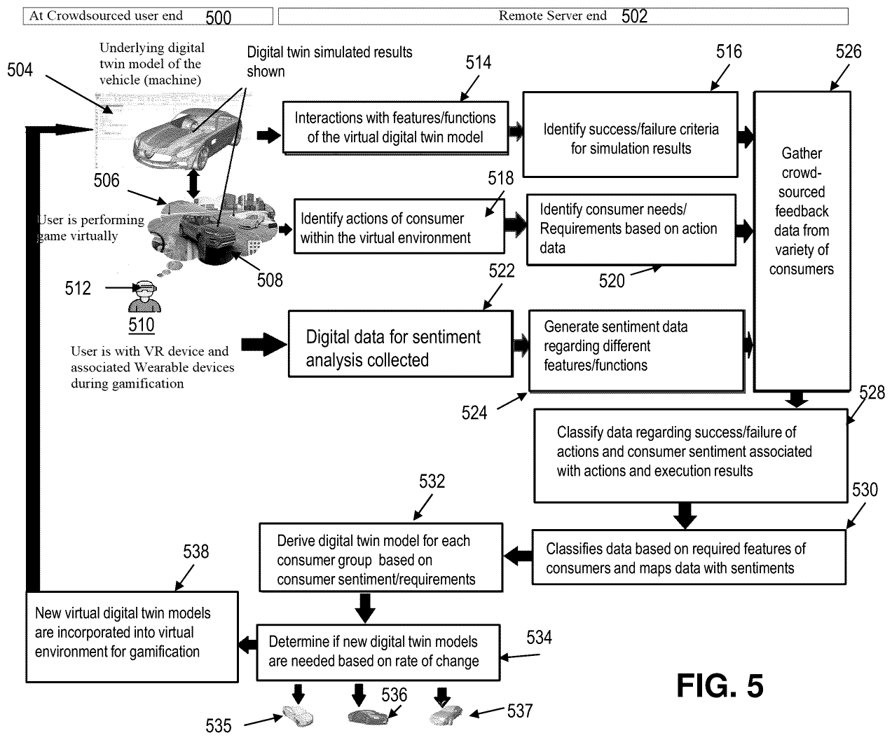

FIG. 5 illustrates an exemplary use scenario in accordance with aspects of the invention. In the scenario of FIG. 5, there is a crowdsourced user end 500 (including user devices 206A, 206B and 212, for example) and a remote server end 502 (including server 204, for example). A digital twin model of a vehicle 504 is utilized in a virtual environment 506 as a virtual digital twin model 508, and a consumer 510 utilizes a virtual reality (VR) device represented at 512 and associated wearable devices (such as a smartwatch not shown) during gamification within the virtual environment 506.

At 514, the consumer 510 performs actions in the virtual environment 506 to interact with and/or execute features/functions of the virtual digital twin model 508 via a user interface provided to the VR device 512 by the server 204. In the example of FIG. 5, the actions of the consumer 510 are performed during a gamification session, which incorporates elements of game play within the virtual environment 506 to encourage engagement of the user with the virtual digital twin model 508. Digital data generated via the consumer interactions in the virtual environment 506 is obtained by the server 204, and analyzed at 516 to identify success criteria and failure criteria for simulated actions of the virtual digital twin model 508 in the virtual environment 506 with respect to the consumer's needs/requirements (as part of classification of the user interaction data).

At 518, the virtual environment 506 gathers data (e.g., image data) identifying actions taken by a consumer during the gamification session within the virtual environment 506. At 520, the server 204 identifies the consumer's needs/requirements based on the actions taken by the consumer during the gamification session (as part of classification of the user interaction data).

At 522, digital data utilized to derive sentiment data of the consumer 510 is collected at the user end 500 during the gamification session and shared with the server 204 at the server end 502. The digital data may include biofeedback data of the consumer 510 captured by one or more user devices (e.g., IoT devices, wearable devices), audio data capturing a voice of the consumer 510, and digital image data of the consumer 510, for example. At 524, the server 204 obtains the digital data and generates (e.g., via NLP) sentiment data regarding the consumer's sentiment associated with different features/functionalities of the virtual digital twin model.

At 526, the server 204 gathers crowd-sourced feedback data from a variety of consumers (including consumer 510), including data from steps 516, 520 and 524. The server 204 then classifies the crowd-sourced feedback data at 528 based on: (1) virtual actions implemented during the gamification session and success or failure of execution of those virtual actions; and (2) sentiment of the consumers regarding different functions and capabilities of the virtual digital twin model 508, and regarding execution results of the virtual actions.

At 530, the server 204 aggregates classified data and further classifies the data based on required (and feasible/possible) features of consumers, and maps the classified data with consumer sentiments. At 532, the server 204 derives a different digital twin model for each different class of consumer based on the required features of the consumers and the consumers' sentiments.

At 534, the server 204 determines if the number of digital twin models has stabilized or if additional digital twin models are needed based on a rate of change of the digital twin models over time. In the example of FIG. 5, the server 204 has generated three digital twin models indicated at 535, 536 and 537.

At 538, the virtual environment 506 is updated to include new virtual digital twin models based on the new digital twin models 535-537, and the new virtual digital twin models are accessed by consumers during additional gamification sessions to generate additional user interaction data. In this way, additional iterations of the process of FIG. 5 may be performed to generate new versions of the vehicle 504 at issue in the form of digital twin models, which may be utilized by a manufacturer to generate physical versions of the digital twin models for marketing to respective groups of consumers.

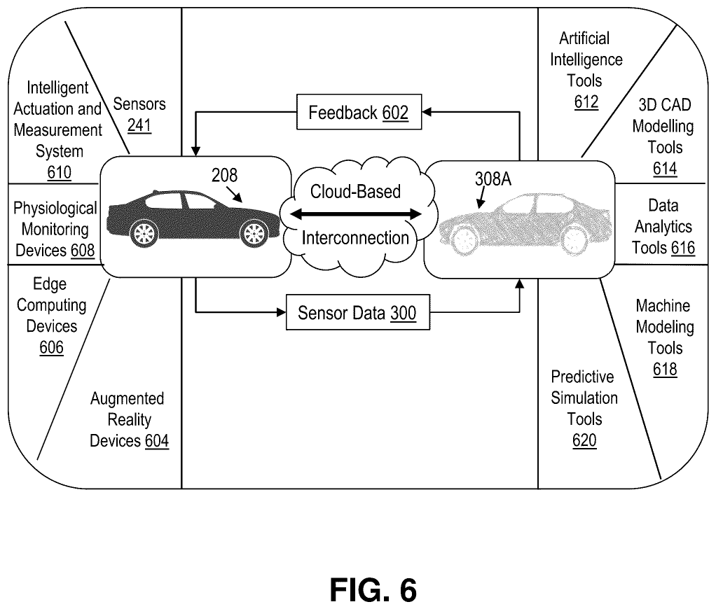

FIG. 6 illustrates technical inputs of an automated product design system in accordance with aspects of the invention. Steps depicted may be carried out in the environment of FIG. 2 and are described with reference to elements depicted in FIGS. 2 and 3.

In the physical realm, a physical product at issue 208 is associated with sensors 241 that generate sensor data 300 regarding features and functions of the physical product 208. The sensor data 300 is utilized to generate a digital twin model 308A, and the digital twin model 308A is utilized in a virtual environment (e.g., 310) as a virtual digital twin model to generate user feedback 602, which is used by the system to generate potential new versions of the physical product 208. Various computing tools in the physical realm may be utilized to collect user feedback 602 of a consumer participating in the virtual environment, including augmented reality devices 604, edge computing devices 606, and physiological monitoring devices 608. In implementations, data can be obtained from and provided to an intelligent actuation and measurement system 610 for manufacturing the product 208.

In the computing realm, various artificial intelligence (AI) tools 612 and three-dimensional (3D) computer-aided design (CAD) modeling tools 614 may be utilized by the server 204 or a third party to generate the digital twin model 308A. Data analytics tools 616, such as various classification tools, may be utilized to derive information from user feedback 602, and the server 204 may utilize this information as input to machine modeling tools 618 and predictive simulation tools 620 (e.g., a ML predictive model) to generate a predictive output (e.g., one of more different models of car for different groups of consumers).

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
converting, by a processor set, a digital twin model of a physical product having a primary design to a virtual digital twin model enabling user interactions with features of the virtual digital twin model in a virtual environment;
collecting, by the processor set, user interaction data generated from virtual interactions of users with the features of the virtual digital twin model in the virtual environment;
generating, by the processor set, sentiment data indicating a sentiment of the users associated with the virtual interactions of the users with the features of the virtual digital twin model; and
inputting, by the processor set, the user interaction data, the sentiment data, and different groups of the users into a trained machine learning (ML) predictive model, thereby generating, as an output of the ML predictive model, a different secondary design of the physical product for each of the different groups of users.

2. The method of claim 1, further comprising classifying, by the processor set, the user interaction data to generate classified data regarding the virtual interactions of the users, wherein the inputting the user interaction data comprises inputting the classified data.

3. The method of claim 1, wherein the ML predictive model generates the different secondary designs of the physical product based on a number of users in each of the different groups of users meeting a threshold number of users.

4. The method of claim 1, wherein the ML predictive model generates the different secondary designs of the physical product based on stored cost versus benefits rules and manufacturing information regarding features of the physical product.

5. The method of claim 1, wherein the user interaction data is selected from one or more of the group consisting of: text-based data from the users, audio data from the users, and biofeedback data from the users.

6. The method of claim 1, wherein the different groups of users are classified groups of users, and the method further comprises classifying, by the processor set, the users into the classified groups of users based on the classified data and the sentiment data.

7. The method of claim 1, further comprising creating, by the processor set, the digital twin model of the physical product based on obtained sensor data of the physical product.

8. The method of claim 1, further comprising iteratively generating, by the processor set, additional secondary designs of the physical product for the respective groups of users as an output of the ML predictive model at different points in time by inputting additional user interaction data, additional sentiment data, and additional groups of users into the ML predictive model based on additionally user interaction data collected over time.

9. The method of claim 8, wherein the iteratively generating the additional secondary designs of the product comprises:
generating, by the processor set, a new digital twin model for each of the one or more secondary designs;
converting, by the processor set, the new digital twin model for each of the one or more secondary designs to a new virtual digital twin model for each of the one or more secondary designs enabling additional user interactions with a set of features of the new virtual digital twin model for each of the one or more secondary designs in the virtual environment;
collecting, by the processor set, additional user interaction data generated from additional virtual interactions with the new virtual digital twin model for each of the one or more secondary designs of the product in the virtual environment;
generating, by the processor set, the additional sentiment data indicating other sentiment of the users associated with the additional virtual interactions of the users; and
inputting, by the processor set, the additional user interaction data, the additional sentiment data, and determined groups of users into the trained ML predictive model, thereby generating the additional secondary designs of the product for the respective ones of the determined groups of users.

10. The method of claim 8, further comprising:
determining, by the processor set, a rate of change of product design based on a comparison of secondary product designs generated at consecutive points in time;
determining, by the processor set, whether the rate of change of the product design meets a saturation threshold; and
determining, by the processor set, whether to proceed with additional iterations of the generating additional secondary designs of the physical product based on the determining whether the rate of change of the product design meets the saturation threshold.

11. The method of claim 8, further comprising generating and sending, by the processor set, a final list of secondary product designs to a user.

12. A computer program product comprising one or more computer readable storage media having program instructions collectively stored on the one or more computer readable storage media, the program instructions executable to:
convert a digital twin model of a physical product having a primary design to a virtual digital twin model enabling user interactions with features of the virtual digital twin model in a virtual environment, wherein the digital twin model accurately mimics real-world features of the physical product;
collect user interaction data generated from virtual interactions of users with the features of the virtual digital twin model in the virtual environment during gamification;
generate sentiment data indicating a sentiment of the users associated with the virtual interactions of the users with the features of the virtual digital twin model; and
input the user interaction data, the sentiment data, and different groups of the users into a trained machine learning (ML) predictive model, thereby generating, as an output of the ML predictive model, a different secondary design of the physical product for each of the different groups of users, wherein the different secondary designs each include a unique combination of the features of the physical product.

13. The computer program product of claim 12, wherein the user interaction data is selected from one or more of the group consisting of: text-based data from the users, audio data from the users, and biofeedback data from the users.

14. The computer program product of claim 12, wherein the program instructions are further executable to create the digital twin model of the physical product based on obtained sensor data of the physical product.

15. The computer program product of claim 12, wherein the program instructions are further executable to iteratively generate additional secondary designs of the physical product for different groups of users as an output of the ML predictive model at different points in time by inputting additional user interaction data, additional sentiment data, and additional groups of users into the ML predictive model based on additionally user interaction data collected over time.

16. The computer program product of claim 12, wherein the program instructions are further executable to:
determine a rate of change of product design based on a comparison of secondary product designs generated at consecutive points in time;
determine whether the rate of change of the product design meets a saturation threshold; and
determine whether to proceed with additional iterations of the generating additional secondary designs of the physical product based on the determining whether the rate of change of the product design meets the saturation threshold.

17. A system comprising:
a processor set, one or more computer readable storage media, and program instructions collectively stored on the one or more computer readable storage media, the program instructions executable to:
convert a digital twin model of a physical product having a primary design to a virtual digital twin model enabling user interactions with features of the virtual digital twin model in a virtual environment, wherein the digital twin model accurately mimics real-world features of the physical product;
collect user interaction data generated from virtual interactions of users with the features of the virtual digital twin model in the virtual environment during gamification;
generate sentiment data indicating a sentiment of the users associated with the virtual interactions of the users with the features of the virtual digital twin model; and
input the user interaction data, the sentiment data, and different groups of the users into a trained machine learning (ML) predictive model, thereby generating, as an output of the ML predictive model, a different secondary design of the physical product for each of the different groups of users, wherein the different secondary design each include a unique combination of the features of the physical product.

18. The system of claim 17, wherein the program instructions are further executable to create the digital twin model of the physical product based on obtained sensor data of the physical product.

19. The system of claim 17, wherein the program instructions are further executable to iteratively generate additional secondary designs of the physical product for different groups of users as an output of the ML predictive model at different points in time by inputting additional user interaction data, additional sentiment data, and additional groups of users into the ML predictive model based on additionally user interaction data collected over time.

20. The system of claim 17, wherein the program instructions are further executable to:
determine a rate of change of product design based on a comparison of secondary product designs generated at consecutive points in time;
determine whether the rate of change of the product design meets a saturation threshold; and
determine whether to proceed with additional iterations of the generating additional secondary designs of the physical product based on the determining whether the rate of change of the product design meets the saturation threshold.
